(19) United States
(12) Patent Application Publication
(10) Pub. No.: US 2003/0196461 A1
(43) Pub. Date: Oct. 23, 2003

(54) Padlock

(76) Inventor: Gaieter Liou, Kaohsiung City (TW)

Correspondence Address: Bacon & Thomas, 4th Floor, 625 Slaters Lane, Alexandria, VA, 22314, US

(21) Appl. No.: 10/123,284

(22) Filed: Apr. 17, 2002

(51) Int. Cl. E05B 67/24

(52) U.S. Cl. 70/38 A; 70/386

(57) ABSTRACT

A padlock includes a casing having a opening for receiving a cylindrical tumbler and a cylinder assembly. The cylinder assembly has a rotary cylinder capable of being turned by a key. The rotary cylinder has a paw adapted to abut a butt of the cylindrical tumbler and thus to turn the tumbler. The tumbler is configured to push a pair of balls into curved notches of a shackle and allow the balls to exit from the notches. Furthermore, the tumbler is provided with a detent positioned in an angular space between the paw and the butt, so as to prevent the paw of the rotary cylindrical from being turned relative to the butt of the cylindrical tumbler.

### BACKGROUND OF THE INVENTION

1. Field of the Invention

The present invention relates to a padlock and, more particularly, to a padlock in which the correct key is not allowed to be pulled out after the padlock is opened, so as to prevent the door of a building, especially of a warehouse, from being locked up while the key is left in the building.

2. Description of Related Art

As shown in FIG. 7, a conventional padlock used for a warehouse includes a casing 90 receiving a cylinder assemble 91 that has a rotary cylinder capable of being turned by a correct key. The rotary cylinder has an upper paw 92 contoured as half a round. Received in the casing 90 above the rotary cylinder is a cylindrical tumbler 93 that has a lower butt 94 contoured as a quarter of a round engagable with the upper paw 92.

When the rotary cylinder is turned away from its original position by the correct key, the paw 92 will press the butt 94 and hence turn the cylindrical tumbler 93 until a pair of curved grooves 95 defined in the periphery of the tumbler 93 are aligned with a pair of movable balls 96. The two balls 96 are then moved into the grooves 95 from curved notches 98 of a shackle 97. Consequently, the released shackle 97 can be raised relative to the casing 90 and the padlock is opened.

In the conventional padlock, however, the butt 94 contoured as a quarter of a round allows the rotary cylinder to be turned by the correct key in an opposite direction even after the padlock has been opened. Once the rotary cylinder returns to its original position, the key can be pulled out. Yet the opened padlock without the key can be closed again simply by depressing the shackle 97. The separation of the key from the opened padlock results in a possibility that the door of a building, especially of a warehouse, may be locked up while the key is left in the building.

### SUMMARY OF THE INVENTION

The object of the present invention is to overcome the aforementioned problem and to provide a padlock in which the correct key is not allowed to be pulled out after the padlock is opened.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a first preferred embodiment of a padlock in accordance with the present invention;

FIG. 2 is a transverse cross-sectional view showing the padlock of FIG. 1 in its closed position;

FIG. 3 is a cross-sectional view taken along lines 3-3 in FIG. 2;

FIG. 4 is a transverse cross-sectional view showing the padlock of FIG. 1 in its open position;

FIG. 5 is a cross-sectional view taken along lines 5-5 in FIG. 4;

FIG. 6 is an exploded perspective view of a second preferred embodiment of the padlock in accordance with the present invention; and

FIG. 7 is a transverse cross-sectional view of a conventional padlock used for a warehouse.

### DETAILED DESCRIPTION OF THE PREFERRED EMBODIMENT

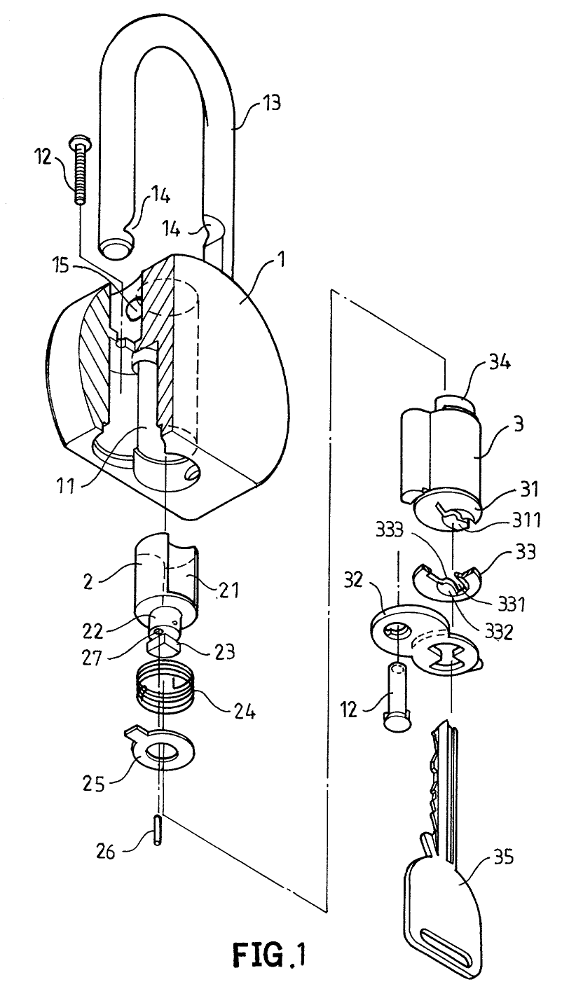

FIG. 1 shows a first embodiment of a padlock in accordance with the present invention for locking the door of a building, especially a warehouse. The padlock includes a casing 1, a cylindrical tumbler 2 and a cylinder assembly 3.

The casing 1 has an opening 11 defined therein for receiving both the cylindrical tumbler 2 and the cylinder assembly 3, with the assembly 3 retained in the opening 11 by means of a fastening 12, such as in the form of a screw. The casing 1 is further formed with a movable shackle 13 that defines a pair of curved notches 14 for partially receiving a pair of opposed balls 15, which is movable laterally in the opening The cylindrical tumbler 2, rotatably received in the opening 11 of the casing 1, has a periphery that defines a pair of curved grooves 21 (only one is shown) to receive the balls 15. The tumbler 2 is further formed with a neck 22 terminating in a butt 23, with a torsion spring 24 and a retainer ring 25 mounted around the neck 22. The torsion spring 24 is provided for urging the tumbler 2 to turn back to its original angular position within the opening 11, and the butt 23 is contoured as a sector less than half a round, preferably as a sector about a quart of a round which has an arched edge projecting from the periphery of the neck 22.

Furthermore, the cylindrical tumbler 2 is provided with a detent 26 extending outward axially from a bottom end of the tumbler 2, for the purpose which is to be described hereinafter. In the illustrated embodiment, the detent 26 is configured as a pin partially fitted in a hole 27 defined in the bottom end of the tumbler 2.

The cylinder assembly 3 is also received in the opening 11 of the casing 1 and is retained therein by the fastening 12, as mentioned above. This assembly 3 has a rotary cylinder 31 adapted to be turned by a correct key 35, and the cylinder 31 is formed with a paw 34, contoured as half a round, that extends more deeply into the casing 11 to abut the butt 23 of the cylindrical tumbler 2.

Preferably, the rotary cylinder 31 is covered with a hard guard 33 which is in turn covered with a protective cover 32. The guard 33 may be made of any heat-treated metal having a hardness sufficient to protect the rotary cylinder 31 from illegal destruction with a drilling tool. The guard 33 should be rotatable synchronously with the rotary cylinder 31 and be formed with a slot 331 allowing the correct key 35 to be inserted into the cylinder 3.

It is more preferable that the guard 33 has a recess 332 defined in a lower face thereof in a location adjacent to the slot 331 to lead to an easy insertion of the key 35. In the preferred embodiment, accompanying the formation of the off-centered recess 332 in the lower face, the guard 33 may be formed in its upper face with a protrusion 333 shaped to mate with a pit 331 of the cylinder 31, thereby ensuring the synchronous rotation of the guard 33 with the rotary cylinder 31.

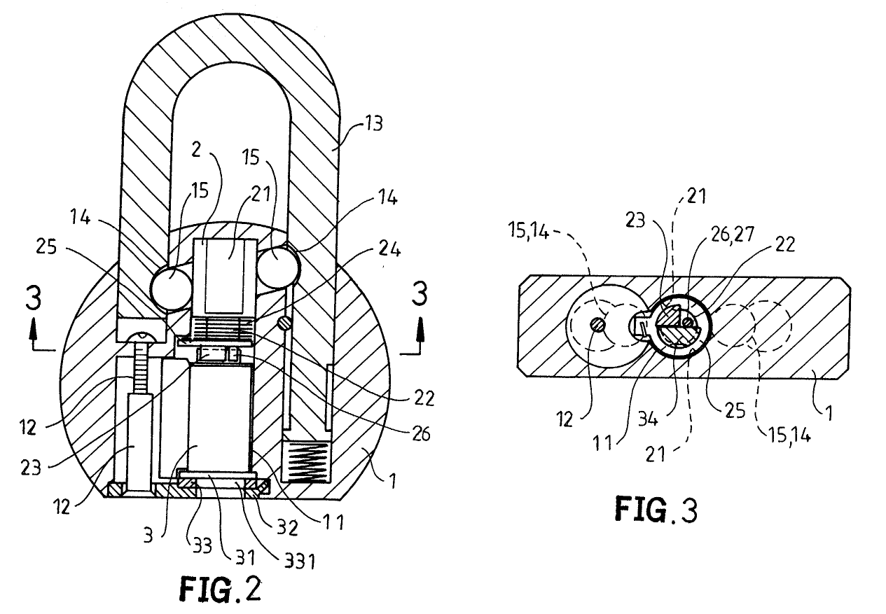

FIG. 2 shows the first embodiment of the padlock being in a closed position. Now the cylindrical tumbler 2 and the cylinder assembly 3 are retained sequentially in the opening 11 of the casing 1 by the fastening 12. And the balls 15 are laterally moved into the curved notches 14, thus remaining the shackle 13 in its depressed position. At this time, the paw 34 of the rotary cylinder 31 abuts the butt 23 of the cylindrical tumbler 2 in a manner as shown in FIG. 3, and the detent 26 formed on the tumbler is positioned in an angular space between the paw 34 and the butt 23.

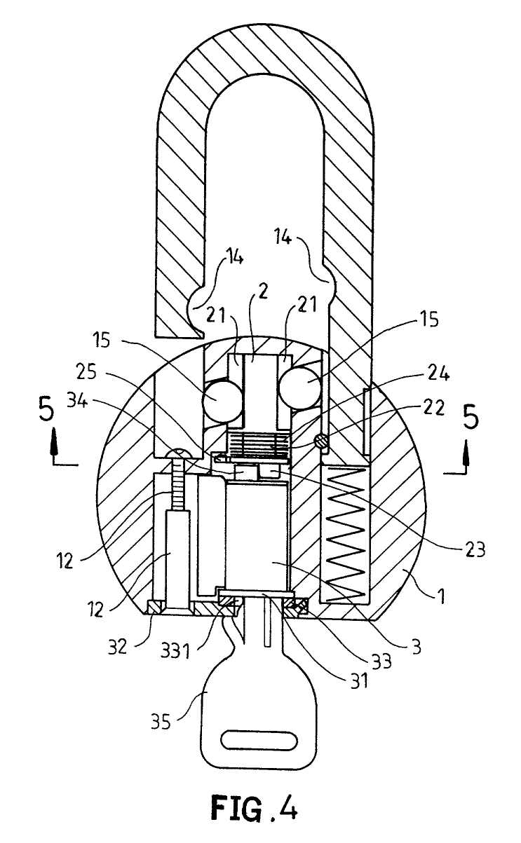

FIG. 4 shows the first embodiment of the padlock being in a open position after the rotary cylinder 31 is turned away from its original position by the key 35. During the turning process of the cylinder 31, the paw 34 pushes the butter end 23 and hence turns the tumbler 2 to such a position that the curved grooves 21 of the tumbler 2 are aligned with the respective balls 15, which are then immediately moved from the curved notches 14 into the grooves 21. As a result, the released shackle 13 is raised by a compressed spring (not numbered), and so the padlock is opened.

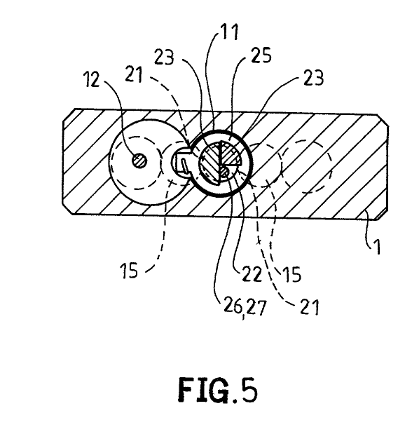

The key 35 can never be pull out directly from the cylinder 31 which has been turned away from its original position, due to the mechanism involving the rollers in the cylinder 31 as well known in the art. The key 35 can be pull out only when the cylinder 31 is turned back to its original position. If the cylinder 31 is intended to be turned back with the key 35, the paw 34 would be turned, for example, in a counterclockwise direction as view in FIG. 5. The paw 34 then tends to push the detent 26 and hence to turn the tumbler 2, which, however, is motionless now because the balls 15 in its curved grooves 21 is not allowed to return to the notches 14 in the raised shackle 13. In one word, the arrangement of the detent 26 prevents the key 35 from being turned and pulled out until the padlock is closed again, i.e., the shackle 13 is depressed.

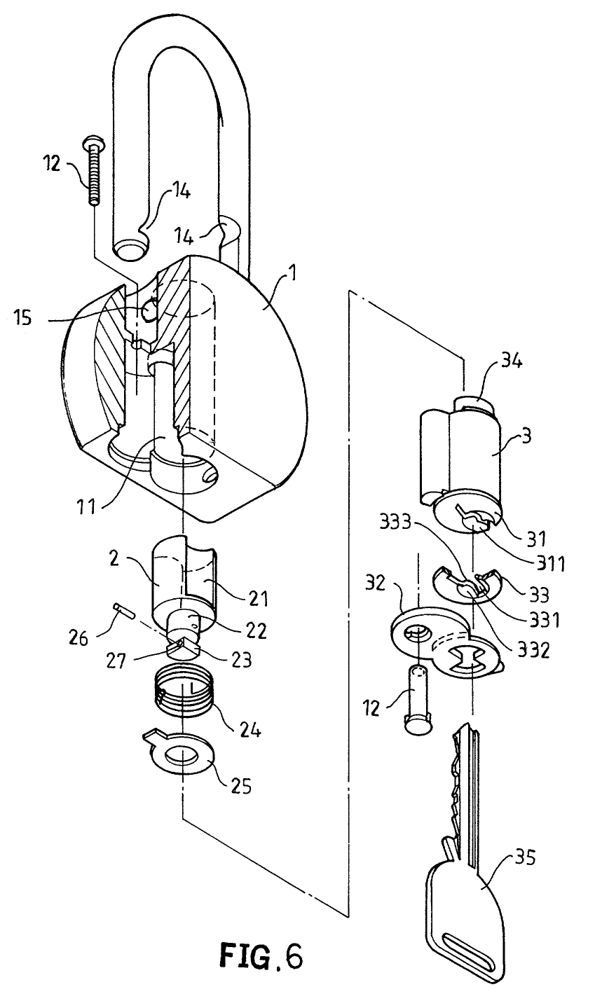

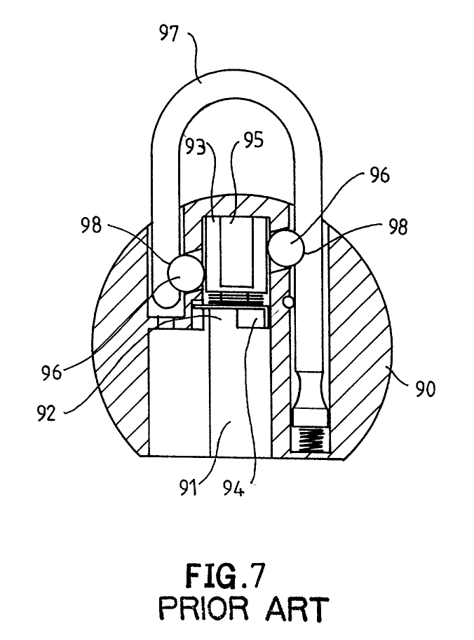

FIG. 6 shows a second embodiment of the padlock in accordance with the present invention. In this embodiment, the cylindrical tumbler 2 is provided with a detent 26 extending outward radially from the butt 23. This detent 26 is positioned in the angular space between the paw 34 and the butt 23, thus preventing the key 35 from being pulled out after the padlock is opened.

From the foregoing, it is clear that the invention has an advantage of preventing the correct key from being pulled out as soon as the padlock is opened. With the inventive padlock, the door of the warehouse will not be locked up while the key is left in the room or the building. Furthermore, the protective cover and the hard guard may effectively protect the inventive padlock from illegal destruction.

It is to be understood that the present invention can be implemented in many other form without departing the spirit and principle thereof and that the disclosure in the preferred embodiments is illustrative only, but not a limitation thereto. The prevent invention is intended to cover all the modifications and verifications which falls into the scope of the invention defined in the appending claims.

What is claimed is:

1. A padlock comprising:
a casing having an opening defined therein and a pair of opposed balls laterally movable in said opening, said casing being formed with a movable shackle defining a pair of curved notches for partially receiving said balls;
a cylinder assembly received in said opening of said casing, said cylinder assembly having a rotary cylinder formed with a paw extending more deeply into said opening;
a cylindrical tumbler received in said opening of said casing behind said rotary cylinder, said cylindrical tumbler having a periphery defining a pair of curved grooves for partially receiving said balls, said tumbler,being formed with a neck terminating in a butt abutting said paw of said rotary cylinder, said tumbler being further formed with a torsion spring and a retainer ring both mounted around said neck; and
wherein said cylindrical tumbler is provided with a detent positioned in a angular space between said butt and said paw, thereby preventing said correct key from being turned and hence being pulled after said padlock is opened.

2. The padlock as claimed in claim 1, wherein said detent extends outward axially from an end face of said cylindrical tumbler.

3. The padlock as claimed in claim 1, wherein said detent extends outward radially from said butt of said cylindrical tumbler.

4. The padlock as claimed in claim 1, wherein said detent is configured as a pin, and wherein said cylindrical tumbler defines a hole in which said pin is fitted.

5. The padlock as claimed in claim 1, wherein said cylindrical assembly further includes a hard guard covering said rotary cylinder and a protective cover covering said hard guard, and wherein said hard guard is rotatable with said rotary cylinder and is formed with a slot allowing said correct key to be inserted into said rotary cylinder.

6. The padlock as claimed in claim 5, wherein said hard guard is made of a heat-treated metal.

7. The padlock as claimed in claim 6, wherein said hard guard has a recess adjacent to said slot thereof.
